(19) United States
(12) Patent Application Publication
(10) Pub. No.: US 2012/0188481 A1
(43) Pub. Date: Jul. 26, 2012

(54) LCD APPARATUS

(75) Inventors: Chai Kang, Shenzhen (CN); Nanfang Xie, Shenzhen (CN)

(73) Assignee: Shenzhen New Super-Bright LCD Display Co. Ltd., Shenzhen, Guangdong (CN)

(21) Appl. No.: 13/498,728

(22) PCT Filed: Sep. 29, 2009
(86) PCT No.: PCT/CN2009/074323

§ 371 Date: Apr. 10, 2012

(51) Int. Cl. G02F 1/1335

(52) U.S. Cl. 349/61

(57) ABSTRACT

A display apparatus comprising first and second liquid crystal display (“LCD”) modules, each LCD module comprising an LCD cell and a backlight arrangement which is arranged to provide backlight illumination to an image display screen of the LCD cell; wherein a ventilation channel is defined between the two LCD modules; characterized in that air-moving arrangements are provided to move air across the ventilation channel to dissipate heat generated by the backlight modules during operation. Such arrangements facilitate the implementation of ultra-bright LCD displays which could function well under bright sunlight while alleviating over-heating issues due to a high intensity of backlight illumination.

### FIELD OF THE INVENTION

The present invention relates to outdoor LCD display apparatus, and more particularly, to backlit outdoor LCD apparatus for mobile applications such as an image displays on the exterior of vehicles.

### BACKGROUND OF THE INVENTION

LCD panels are increasingly used as display apparatus because of their characteristic flat panel, their high image resolution, and their ability to deliver textual and graphic messages with ease in content update and changes. An immediate advantage of such ease in content updating is the possibility to use the LCD panel for time-sharing display applications such that different messages, such as advertising and promotional messages, can be displayed at different selected time slots or intervals to maximize display effectiveness.

For example, US 20080236007 disclosed a flat LCD panel mounted on Taxi tops for use as an advertising display panel.

Backlit LCD panels are particularly suitable for outdoor display applications because the display brightness could be adjusted by varying the backlight illumination level according to the instantaneous ambient lighting conditions. For example, very bright backlighting will be required when the LCD panel is displaying images under bright sunlight to enable viewing of the displayed images from a reasonable or useful distance, while only minimal or lesser backlighting is required for night operations or when the ambient brightness level is low.

However, the harsh outdoor operating conditions could be adverse to the operation life of an LCD display. For example, when an LCD panel is exposed directly under sunlight, the surface temperature of the LCD panel could rise to above 80° C. A prolonged exposure to such high temperatures could result in premature darkening of an LCD screen, resulting in premature failure of the LCD panel. Such high ambient temperatures coupled with the heat generated due to a bright backlighting is a major problem which needs to be mitigated in order to enable backlit LCD to be commercially viable as an outdoor image display or as a cost effective advertising medium.

Therefore, it would be advantageous if there could be provided improved LCD apparatus that alleviate shortcomings of conventional LCD apparatus.

### SUMMARY OF THE INVENTION

According to the present invention, there is provided a display apparatus comprising first and second liquid crystal display (“LCD”) modules, each LCD module comprising an LCD cell and a backlight arrangement which is arranged to provide backlight illumination to an image display screen of the LCD cell; wherein a ventilation channel is defined between the two LCD modules; characterized in that air-moving arrangements are provided to move air across the ventilation channel to dissipate heat generated by the backlight modules during operation. Such arrangements facilitate the implementation of ultra-bright LCD displays which could function well under bright sunlight while alleviating over-heating issues due to a high intensity of backlight illumination.

The LCD modules may be arranged to display images for viewing on opposite sides of the apparatus. These facilities enhanced message broadcasting effect of a single apparatus.

The ventilation channel may extend longitudinally along the length of the first and second LCD modules and the first and the second LCD modules may be connected at their upper and lower ends; characterized in that the air-moving arrangements are positioned at one longitudinal end of the ventilation channel and are arranged to move air across the ventilation channel and then to the other longitudinal end of the ventilation channel whereby heat generated by the backlight arrangements is dissipated by the flow of air.

These and other features of the invention will be explained below in further details below.

### BRIEF DESCRIPTION OF THE DRAWINGS

An exemplary embodiment of the present invention will be described below by way of example with reference to the accompany drawings, in which,

FIG. 1 is a front perspective view of an embodiment of an outdoor LCD apparatus of the present invention,

FIG. 2 is a front perspective view of the apparatus of FIG. 1 from the right side with the external housing removed,

FIG. 3 is a front perspective view of the apparatus of FIG. 1 from the left side with the external housing removed,

FIG. 4 is a top plan view of FIGS. 2 & 3,

FIG. 5 is a cross-sectional view along line B-B of FIG. 4, and

FIG. 6 is a cross-sectional view along line A-A of FIG. 4.

### DETAILED DESCRIPTION OF THE EMBODIMENTS

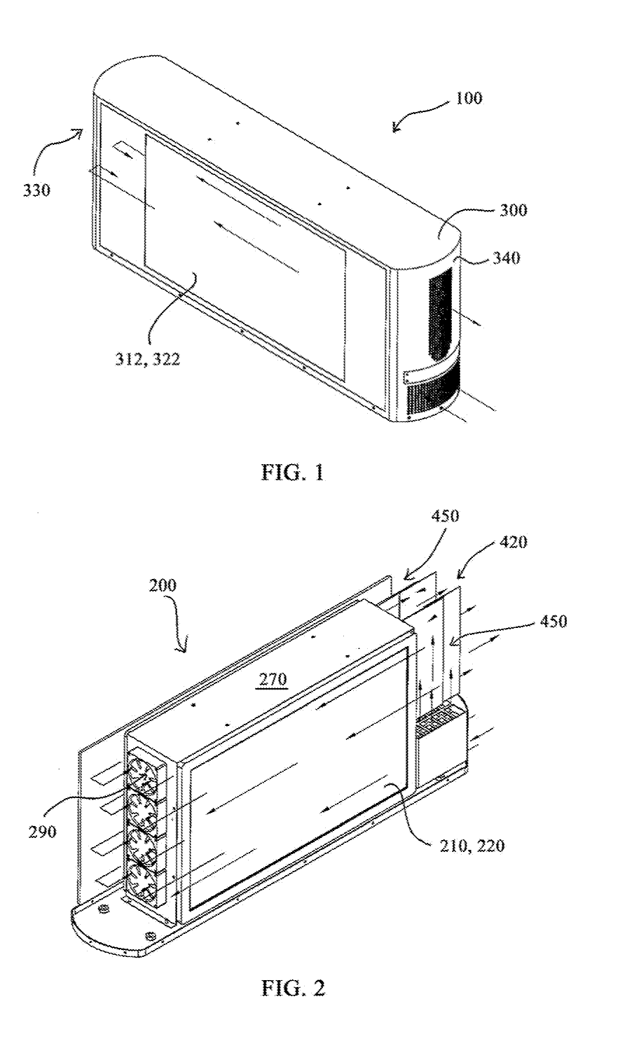

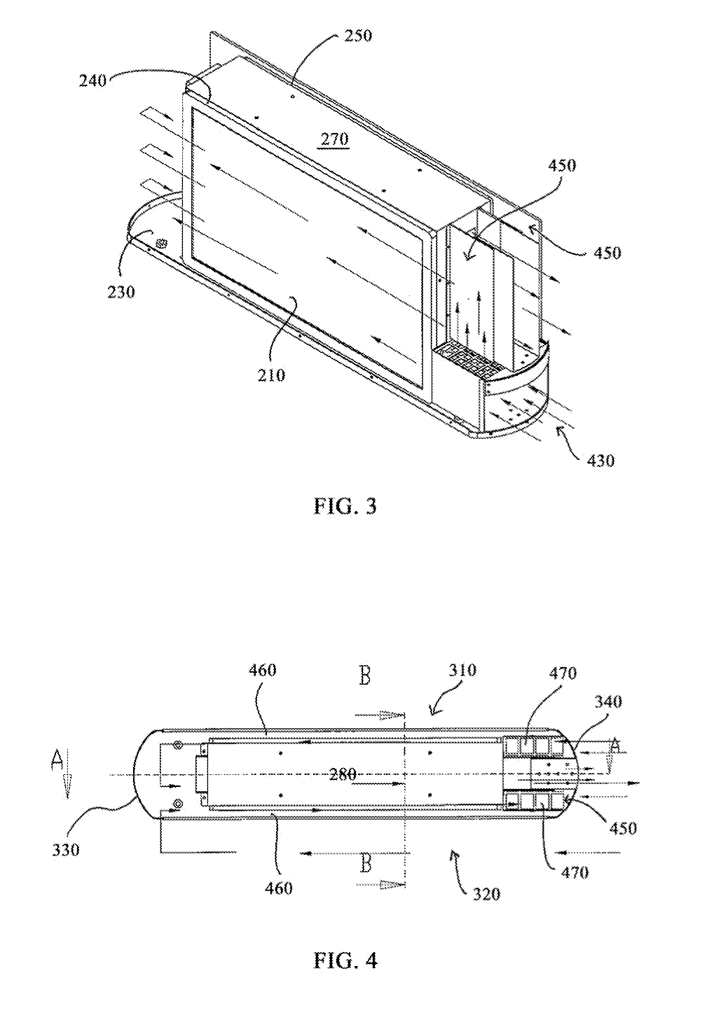

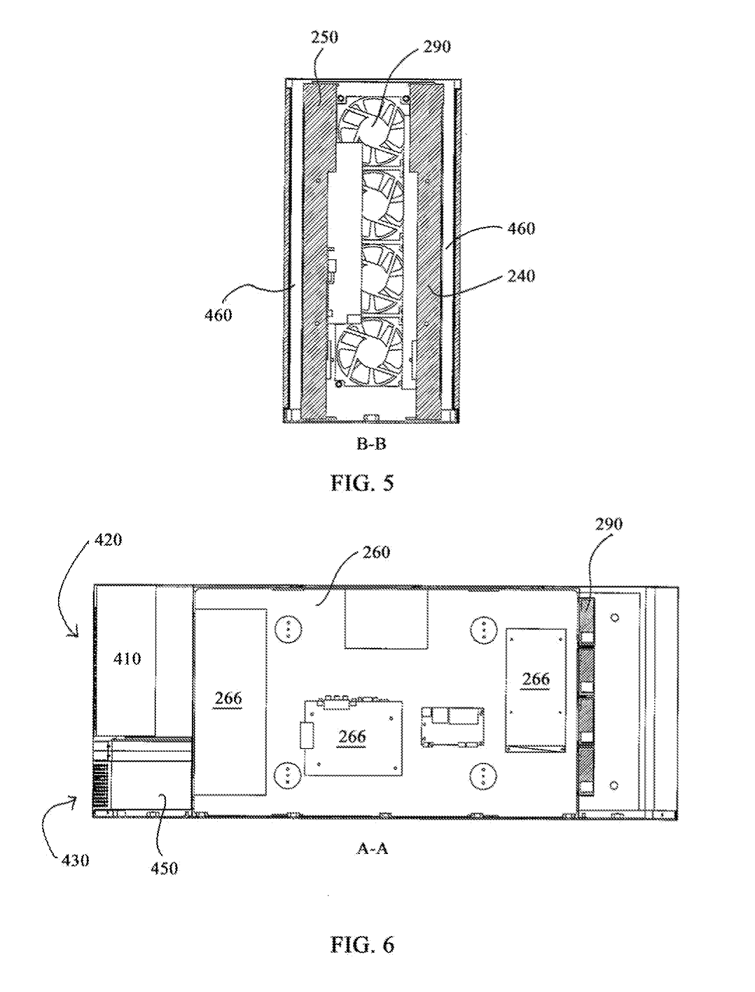

A vehicle mountable outdoor LCD display apparatus 100 implementing an embodiment of the present invention is shown in FIGS. 1 to 6. The display apparatus 100 comprises an LCD display assembly 200 which is mounted inside an outer housing 300. The outer housing 300 comprises a rigid shell for receiving the LCD display assembly and for providing weather shielding to the LCD display assembly so that the LCD display assembly 200 can function under harsh outdoor weather conditions.

The ventilation channel may extend longitudinally along the length of the first and second LCD modules and the first and the second LCD modules are connected at their upper and lower ends; characterized in that the air-moving arrangements are positioned at one longitudinal end of the ventilation channel and are arranged to move air across the ventilation channel and then to the other longitudinal end of the ventilation channel whereby heat generated by the backlight arrangements is dissipated by the flow of air.

The rigid shell defines a generally rectangular compartment and includes two opposite major surfaces 310, 320 on which viewing windows 312, 322 are formed. The viewing windows are formed on the two major surfaces 310, 320 to provide large viewing surfaces so that video and text messages could be communicated effectively to viewers outside a vehicle on which the apparatus is mounted. The rigid shell is moulded of hard plastics and each of the windows 312, 322 is mounted with a transparent sheet of polycarbonate to provide a robust protection to the adjacent LCD screen. Alternatively, the rigid shell could be formed of metallic sheet, such as rust-free or stainless steel or aluminium sheets, and the transparent sheet could be made of tampered glass or other hard transparent plastics.

The LCD display assembly 200 are mounted relative to the rigid shell to permit viewing of images being displayed on the LCD display screens while providing a ventilation path to condition the surface temperature of the LCD display surface. Specifically, the LCD assembly 200 is mounted with an LCD display screen 210,220 juxtaposing a corresponding transparent window to facilitate a maximal viewing angle of the LCD display screen from the outside. The LCD display screen is mounted spaced apart from the transparent window to form an air flow path or air flow compartment. The air flow path or air flow compartment is provided so that conditioning air flowing along the air flow path or compartment could exchange heat directly with the LCD screens to mitigate adverse effects on the LCD screens due to extreme outside ambient temperatures.

The surfaces on the longitudinal ends of the rigid shell are minor surfaces 330, 340 which could be used to display permanent textual messages such as a “Taxi” sign. One of the longitudinal ends of the rigid shell is closed, while the other longitudinal end surface is formed with ventilation means, such as ventilation apertures, to permit exchange of conditioning air streams, as will be described in more detail below.

The LCD display assembly comprises a rigid base 230 on which upstanding LCD display modules 240, 250 are installed. Each LCD display module 240, 250 comprises an LCD panel and a back panel. The LCD panel comprises an LCD cell 262 which is optically coupled with polarising films and brightness enhancing films to enhance brightness for the images being displayed on the LCD screen. The back panel 260 is mounted with a backlight module 264 and electronic circuitry 266, as depicted in FIG. 6. The backlight module 264 comprises a matrix of LEDs (not shown) as an example of backlight elements. The backlight elements are distributed on the illumination side of the back panel to provide back illumination to the entire LCD cell so that an image appearing on the LCD screen is visible to the human eye upon back illumination. Alternatively, the backlight elements could be fluorescent lamps.

The backlight elements are arranged such that the lighting level of an individual backlight element, or a collection of individual backlight elements, could be selectively adjusted to provide a localised variation or individual variation on the local backlight level in response to the image being displayed. The electronic circuitry comprises video circuitry for converting a stream of incoming video signals into pixels signals for individual pixels of the LCD cell to display still or video pictures, receiver circuitry for receiving incoming video signals and incoming commands transmitted from an external transmitter, video controller for processing message signals received by the receiver and converting the signals for output to the video circuitry, and backlight controller to dynamically control the backlighting module such that the backlighting level can be adjusted in response to the ambient lighting level to maintain a balance between sufficient image brightness, energy preservation and operating life of the LCD panel. The electronic circuitry may further comprise storage device to store message information so that message information could be readily retrieved for display until the next update. In addition, ambient light sensors are provided to detect the instantaneous ambient light level in order to provide instantaneous ambient lighting information to the backlight controller to adjust backlight level.

The first and second LCD modules 240, 250 are mounted on the rigid base 230 in a back-to-back fashion and in a spaced apart manner. In addition, the first and second LCD modules are connected together by a rigid bridging member 270 at their respective top ends so that a robust construction suitable for road vehicle application is formed. With such a construction, a shared ventilation channel 280 extending between the longitudinal ends of the LCD assembly is also formed. Specifically, this shared ventilation channel is defined by the two LCD modules, the rigid base and the rigid bridge member, and its function will be described in more detail below. In addition, a plurality of anchoring apertures 272 is distributed on the rigid base so that the LCD assembly can be robustly secured onto a vehicle, for example, the roof of a Taxi.

Referring to FIGS. 2 to 5, the first and second LCD modules are mounted in a back-to-back manner such that the non-illumination sides of the back panels of the first and second LCD modules are facing each other, while the image displaying surfaces of the LCD modules are distal and facing away from each other. To dissipate heat generated by the backlight elements so that the temperature of the apparatus (especially the temperature of the LCD cell) does not exceed a preferred operating temperature for a prolonged duration, heat dissipation means such as finned metallic heat sinks are mounted on the non-illumination sides of the back panel. To prevent accumulation of wasted heat in the shared ventilation channel, forced air movement means are provided to transport heat away from the ventilation channel. While wasted heat of the apparatus is largely due to heat generated by the backlight modules and dissipated by the heat sinks, it could also be due to heat dissipated by other electronic circuitry of the apparatus.

To remove wasted heat from the ventilation channel, forced air movement devices are provided. Referring to FIGS. 2 to 4, a first set of motorised fans 290 is disposed on one longitudinal end of the LCD assembly for moving wasted heat out of the shared ventilation channel and for subsequent discharge. This longitudinal end on which the first set of motorised fans is mounted is the longitudinal end of the shared ventilation channel which is proximal the closed end of the rigid shell. The motorised fans in this first motorised fan set are distributed along the upstanding or vertical direction of the shared ventilation channel, and are arranged to move air across the shared ventilation channel and towards the other end of the rigid shell that is formed with ventilation means for subsequent discharge. In essence, the air which is being moved across the ventilation channel will carry with it wasted heat dissipated by the heat sinks due to heat exchange therewith, and the waste heat will be removed from the apparatus when the waste heat carrying air is subsequently discharged from the display apparatus.

To facilitate discharge of waste air from the apparatus, a discharge channel 410 is formed between the LCD assembly and the longitudinal end of the rigid shell formed with the ventilation means. This discharge channel is a longitudinal extension of the shared ventilation channel which extends between the LCD assembly and the rigid shell, but has a lesser channel width comparable to that of the shared ventilation channel. The ventilation means on the rigid housing comprises a discharge outlet 420 for waste air discharge.

To provide a continuous supply of conditioning air into the apparatus, an air supply route comprising an air supply inlet 430 and an air supply channel 440 is provided. The air supply channel 440 is intermediate the air supply inlet and the motorised fan end of the shared ventilation channel, and comprises a first portion 450 and a second portion 460. The first portion of the air supply channel comprises the compartment which is formed between the discharge channel and the rigid housing, and the second portion comprises the space between the LCD screen and the transparent window of the outer housing. The second portion is intermediate the first portion and the shared ventilation channel and is arranged to provide an interconnection there-between. As shown in FIGS. 2-4, two air supply routes are provided and each air supply route is adjacent the discharge channel and sandwiching the discharge channel.

The air supply inlet comprises an inlet frontend which is formed on the ventilation means of the rigid housing but which is disposed at a location separate from the discharge outlet to avoid mixing of fresh and waste air. As depicted in FIGS. 1 and 2, the inlet frontend is located beneath the discharge outlet and includes ducting means 470 which are arranged to direct incoming air flow to move in the upstanding direction before moving into the second portion of the air supply channel. To further enhance separation of the incoming and outgoing air streams, directional vanes are provided at the inlet frontend and discharge outlet. For example, an array of upwardly tilted vane could be disposed at the upper discharge outlet, while an array of downwardly tilted vane could be disposed at the air supply inlet.

When the apparatus is in use, video or still picture images generated by the electronic circuitry will be displayed on the LCD screens and the backlight modules will come into operation. Such an operation will generate heat which needs to be dissipated, or otherwise diverted from the shared ventilation channel to ensure a continuous and smooth operation of the apparatus. A thermal sensor or thermostat installed inside the apparatus will trigger the operation of the motorised fans when the temperature rises to above a threshold temperature. When the motorised fans are in operation, a low pressure area will be generated at the closed end of the rigid housing. Such a low pressure area will cause external air to move into the apparatus via the inlet frontend and the air supply channel. When external air is moving across the second portion of the air supply channel, the LCD screen surface is also conditioned by the external air to remove heat accumulated on the display surface. When the external air reaches the set of motorised fans disposed proximal the closed end of the rigid shell, the air will continue to move across the shared ventilation channel and exit at the discharge outlet, thereby dissipating waste heat from the shared ventilation channel and the apparatus.

As an alternative, additional sets of air moving devices, for example motorised fans, are installed at the inlet frontend to cooperate with the first set of motorised fans to improve the conditioning air flow.

In an alternative operating embodiment, the apparatus is adapted for operating in very cold conditions. Under such conditions, the direction of operation of the ventilation fans is reversed such that fresh air is drawn into the apparatus via the discharge outlet and then moves firstly into the shared ventilation channel, then moves to the second portion of the air supply channel, and then exhausted through the inlet frontend.

Under such operating conditions, a low pressure area will be generated at the end of the shared ventilation channel which is proximal the first set of motorised fans. Such a low pressure area will cause external air to move into the shared ventilation channel via the discharge outlet. The first set of motorised fans will then move the air, which carries the heat dissipated in the shared ventilation channel, into the second portion of the air supply channel and warm the LCD display surface so that the LCD cell could operate at a preferred temperature.

While the LCD display screens in the exemplary embodiments above are arranged at a parallel back-to-back relationship and the shared ventilation channels are defined by a pair of substantially parallel back panels, it will be appreciated the LCD display screens or the back panels could be at an angle to each other without loss of generality. Further, while the rigid housing comprises a closed end and an aperture end, it will be appreciated that both longitudinal ends could be aperture so that conditioning air could enter the apparatus at one longitudinal end and leaves at the other longitudinal end while attaining the same objectives of providing conditioning air to the shared ventilation channel and/or the LCD screens. In addition, the terms ‘air supply inlet’, ‘air supply channel’, ‘discharge channel’, ‘discharge outlet’, etc are only terms of convenience references are not meant to impose limitation on the functionality of the features which they refer to. For example, the meanings of the terms ‘discharge’ and ‘supply’ could be reversely used when applying to the alternative embodiment. In the description above, the term ‘waste air’ means air charged with wasted heat.

For the avoidance of doubt, the embodiments described in this specification are only provided to assist understanding of the present invention and should not be construed as limiting the scope of the invention.

List of Numerals

| | | | |
|---|---|---|---|
| LCD Display Apparatus | 100 | Electronic Circuitry | 266 |
| LCD Display Assembly | 200 | Bridging Member | 270 |
| Outer Housing | 300 | Shared Ventilation Channel | 280 |
| Major Surfaces | 310, 320 | Anchoring Apertures | 272 |
| Window | 312, 322 | First Set of Motorized Fans | 290 |
| LCD Screen | 210, 220 | Discharge Channel | 410 |
| Minor Surfaces | 330, 340 | Discharge Outlet | 420 |
| Rigid Base | 230 | Air Supply Inlet | 430 |
| LCD Modules | 240, 250 | Air Supply Channel | 440 |
| Back Panel | 260 | First Portion | 450 |
| LCD Cell | 262 | Second Portion | 460 |
| Backlight Module | 264 | Ducting Means | 470 |

1-15. (canceled)

16. A display apparatus comprising first and second liquid crystal display (“LCD”) modules, each LCD module comprising an LCD image display screen for image viewing and a backlight arrangement which is arranged to provide backlight illumination to the image display screen; wherein a ventilation channel is defined between the first and second LCD modules; characterized in that air-moving arrangements are provided to move air across the ventilation channel to dissipate heat generated by the backlight modules during operation.

17. A display apparatus according to claim 16, wherein the first and second LCD modules are arranged to display images on the image display screens for viewing on opposite sides of the apparatus.

18. A display apparatus according to claim 17, wherein the ventilation channel extends longitudinally along the length of the first and second LCD modules and the first and the second LCD modules are connected at their upper and lower ends; wherein the air-moving arrangements are positioned at one longitudinal end of the ventilation channel and are arranged to move air across the length of the ventilation channel and then to the other longitudinal end of the ventilation channel whereby heat generated by the backlight arrangements is dissipated by the flow of air.

19. A display apparatus according to claim 16, wherein the ventilation channel extends longitudinally along the length of the first and second LCD modules and the first and the second LCD modules are connected at their upper and lower ends; wherein the air-moving arrangements are positioned at one longitudinal end of the ventilation channel and are arranged to move air across the length of the ventilation channel and then to the other longitudinal end of the ventilation channel whereby heat generated by the backlight arrangements is dissipated by the flow of air.

20. A display apparatus according to claim 19, wherein the first and the second LCD modules are upstanding from a base support; and wherein the air-moving arrangement comprises a plurality of motorized fans which are distributed in the upstanding direction.

21. A display apparatus according to claim 16, wherein the first and second LCD modules are mounted on a housing comprising first and second transparent protective screens, the image display screens of the first and second LCD modules juxtaposing the first and second transparent protective screens respectively, wherein a ventilation compartment is formed between each LCD image display screen and the corresponding transparent protective screen, and the air-moving arrangements are also arranged to move air across the ventilation compartment to condition the surface temperature of the LC image display screens.

22. A display apparatus according to claim 16, wherein the air-moving arrangements are arranged to move conditioning air over the image displaying screens of the first and second LCD modules, to combine streams of warmed air after emerging from the image display screens of the first and second LCD modules, and then to move the combined air stream through the ventilation channel to an exhaust to dissipate heat generated by the backlight arrangements.

23. A display apparatus according claim 16, wherein the air-moving arrangements are arranged to move air through the ventilation channel to dissipate heat generated by the backlight arrangements, and then to split and direct air exiting from the ventilation channel to flow across the first and second LCD modules to condition the temperature of the LCD screens.

24. A display apparatus according to claim 16, wherein the apparatus further comprises a temperature sensor for sensing ambient temperature, and the direction of air movement of the air-moving arrangement is reversible according to the detected ambient temperature.

25. A display apparatus according to claim 16, wherein the air-moving arrangements are configured to move curtains of air across the image displaying screens of the LCD modules.

26. A display apparatus according to claim 25, wherein the air moving arrangements comprise a plurality of motorized fans which are distributed to move a curtain of air across the image displaying screens of the LCD modules.

27. A display apparatus according to claim 16, wherein the housing comprises anchoring means for mounting on top of a motor vehicle, such as a Taxi.

28. A display apparatus according to claim 16, wherein each backlight arrangement comprises heat-sinks, the heat sinks having heat dissipating features protruding into the ventilation channel; and the air-moving arrangements are arranged to move cooling air through the ventilation channels so as to dissipate heat from the heat sinks.

29. A display apparatus according to claim 28, wherein the apparatus is arranged such that cooling air enters and leaves the apparatus from the same side of the apparatus, and partitioning arrangements are provided to separate the incoming and outgoing air streams.

30. A display apparatus according to claim 29, wherein the ventilation channel is shared between the two LCD image display modules.

31. A display apparatus according to claim 30, wherein the first and second LCD modules are arranged in a back-to-back configuration such that the image display screens of the LCD modules are facing opposite sides.

32. A display apparatus according to claim 30, wherein an air discharge outlet is formed at one longitudinal end of the shared ventilation channel.

33. A display apparatus according to claim 32, wherein an air supply inlet for supplying outside air to the apparatus is formed at the same longitudinal end of the shared ventilation channel at which the air discharge outlet is located.
